(19) United States
(12) Patent Application Publication
(10) Pub. No.: US 2021/0347100 A1
(43) Pub. Date: Nov. 11, 2021

(54) INJECTION MOLDING MACHINE

(71) Applicant: NIGON MACHINES LTD., Vaughan (CA)

(72) Inventors: Robert D. Schad, Toronto (CA); Michael Goriup, Vaughan (CA); Hemant Kumar, Brampton (CA); Martin Kestle, Vaughan (CA); Brandon Winkels, Bolton (CA); Carsten Link, Burlington (CA)

(73) Assignee: NIGON MACHINES LTD., Vaughan (CA)

(21) Appl. No.: 17/443,030

(22) Filed: Jul. 20, 2021

Related U.S. Application Data
(63) Continuation of application No. PCT/CA2020/050075, filed on Jan. 23, 2020.
(60) Provisional application No. 62/795,819, filed on Jan. 23, 2019.
(60) Provisional application No. 62/915,855, filed on Oct. 16, 2019.

(51) Int. Cl. B29C 45/64; B29C 45/04; B29C 45/17; B29C 45/68; B29C 45/72

(52) U.S. Cl. CPC B29C 45/641; B29C 45/0408; B29C 45/1744; B29C 2045/686; B29C 45/68; B29C 45/72; B29C 2045/688; B29C 45/1747

(57) ABSTRACT

A two-platen clamp apparatus for an injection molding machine includes a first platen having a first mold mounting surface and a second platen having a second mold mounting surface. A first rail and a second rail extend parallel to each other and to a machine axis, the first and second rails disposed at a rail elevation vertically below the machine axis. The second platen is slidably coupled to the first and second rails and translatable between mold-closed and mold-open positions. At least one force-exertion member is coupled to the second platen for clamping the first and second platens together, each clamping force exerted along an axis parallel to and offset vertically below the machine axis. At least one force-reaction member is coupled to the first and second platens for resisting separation of upper portions of the first and second mold mounting surfaces during exertion of the clamping force, each of the at least one force reaction member disposed at an elevation below the machine axis.

This application is a continuation of International Patent Application Serial No. PCT/CA2020/050075, filed Jan. 23, 2020, which claims the benefit of U.S. Provisional Application Ser. No. 62/795,819, filed Jan. 23, 2019 and U.S. Provisional Application Ser. No. 62/915,855, filed Oct. 16, 2019, each of which is hereby incorporated herein by reference.

### FIELD

The specification relates to injection molding machines, and to clamp apparatuses for injection molding machines.

### BACKGROUND

U.S. Pat. No. 3,169,275 (Farrel Corp.) relates to a screw type preplasticizing plastic injection molding machine. One of the objects is to provide a machine of this type permitting the molding of parts requiring a large volume of plastic. Another object is to provide such a machine in a form capable of handling a wide range of plastic compositions.

U.S. Pat. No. 6,503,075 (Husky) relates to stack mold carriers in an injection molding machine with a rotating turret. Services to the rotating turret are provided by a rotary union attached to the translating mold carrier at the turret's axis of rotation. Services such as oil, water, air and electrical power are provided to the rotating turret thereby allowing the turret to rotate in either direction. The rotating turret is attached to linkages which open and closed the molds through connection to a moving and a stationary platen which interface with the rotating turret to form molded articles therein.

DE 19535081 (Ferromatik Milacron) discloses a two-platen injection moulding machine having a positioning drive and guides below the mould assembly area, on which the mould clamping platens move relatively. A separate device applies closure force for injection. The guides are a pair of parallel, horizontal, supporting slide bars, to which one platen is fixed and on which the other slides on bushes. Within these bushes there are clamping devices, preventing relative platen motion after die closure and during injection. One clamping platen is in two parts. One part both carries the mould and floats on the other. The floating mounting is implemented as an oil pressure cushion intermediate to the parts, which is externally pressurised.

U.S. Pat. No. 6,186,770 (Ziv-Av) discloses a two-platen mold-clamping apparatus. A plurality of ball nuts are mounted on a movable platen so as to be rotatable but axially immovable relative to the movable platen. The movable platen mounted for reciprocal motion relative to a stationary platen. A respective ball screw is threadedly engaged with each of the ball nuts and each balls screw has an end portion that is fixed to the stationary platen. A motor rotates the ball nuts by means of sprockets and a chain so that the ball nuts and the movable platen are moved toward the stationary platen. The ball screws are moved longitudinally relative to the movable platen so as to generate a mold-clamping force after a mold-touch state has been reached.

### SUMMARY

The following summary is intended to introduce the reader to various aspects of the applicant's teaching, but not to define any invention.

According to some aspects, a two-platen clamp apparatus for an injection molding machine includes (a) a first platen having a first mold mounting surface for affixing a first mold half thereto, and a second platen having a second mold mounting surface for affixing a second mold half thereto, the second mold mounting surface directed toward the first mold mounting surface; (b) a machine axis passing through respective centerpoints of each mold mounting surface; (c) a first rail and a second rail extending parallel to each other and to the machine axis, the first and second rails disposed at a rail elevation vertically below the machine axis; the second platen slidably coupled to the first and second rails and translatable toward and away from the first platen between mold-closed and mold-open positions; (d) at least one force-exertion member coupled to the second platen, each of the at least one force-exertion member exerting a clamping force along a force application axis for clamping the first and second platens together when in the mold-closed position, each force application axis parallel to and offset vertically below the machine axis; and (e) at least one force-reaction member coupled to the first and second platens for resisting separation of upper portions of the first and second mold mounting surfaces during exertion of the clamping force, the upper portions defined by portions of the mold mounting surfaces at an elevation above the machine axis, each of the at least one force reaction member disposed at an elevation below the machine axis.

In some examples, the clamp apparatus is free of any force transfer members extending between the first and second platens at an elevation above the first and second rails.

In some examples, the at least one force-reaction member comprises a first stabilizer beam and a second stabilizer beam extending parallel to each other and to the machine axis, each beam having a beam length extending between a beam first end and a beam second end, the first platen fixed to the first and second beams proximate the respective beam first ends, and the second platen movably supported on the second beams and translatable toward and away from the first platen between the mold-closed and mold-open positions, each beam having a beam height extending vertically between a beam lower surface and a beam upper surface.

In some examples, each of the first and second mold mounting surfaces has a mold mounting surface height extending vertically between a mold mounting surface lower edge and a mold mounting surface upper edge, and a mold mounting surface width extending laterally between spaced apart mold mounting surface side edges. In some examples, the beam height is at least 75 percent of the mold mounting surface height. In some examples, each beam has a beam thickness extending laterally between opposed side faces, each beam thickness being at least 50 mm.

In some examples, each of the at least one force-exertion member comprises a clamp actuator coupled to at least the second platen for exerting a clamp force across the first and second platens when in the mold-closed position, the clamp actuator comprising a rod member extending along a rod axis, the rod axis parallel to the machine axis and at an elevation below the rails.

In some examples, the clamp actuator comprises a first stage drive for translating the second platen between the mold open and mold closed positions, and a second stage drive for exerting a clamp force across the first and second platens when in the mold closed position.

In some examples, the rod member comprises a ball screw, and the actuator includes a ball nut rotatably coupled to each ball screw, each ball nut and respective ball screw rotatable relative to one another for urging translation of the moving platen and exerting the clamp load.

In some examples, each rod member comprises a tie bar extending between the first and second platens, the clamp actuator exerting a tensile force on the tie bar when exerting the clamp load across the platens.

In some examples, a locking device is associated with each tie bar and mounted in the second platen, each locking device movable between a locked position for transferring axial force from the tie bar to the second platen during clamp-up, and an unlocked position in which the second platen is axially translatable relative to the tie bar, for movement between the mold open and mold closed positions.

In some examples, a platen stroke drive is provided for translating the second platen between the mold-open and mold-closed positions, the platen stroke drive separate from the force exertion member. In some examples, the platen stroke drive comprises a ball nut axially fixed relative to the rails, and a ball screw coupled to the ball nut, the ball screw axially and rotationally fixed relative to the second platen and translatable with the second platen upon rotation of the ball nut. In some examples, the ball screw has an internal cooling conduit extending lengthwise within the ball screw for circulating a cooling fluid to remove heat from the ball screw.

According to some aspects, a two-platen injection molding machine, comprises (a) a base having a clamp support portion for supporting a clamp apparatus and an injection support portion for supporting an injection unit; (b) a first platen and a second platen supported by the clamp support portion of the base, the first platen having a first mold mounting surface for affixing a first mold half thereto, and the second platen spaced horizontally apart from the first platen and having a second mold mounting surface opposed to the first mold mounting surface for affixing a second mold half thereto; (c) a horizontally oriented machine axis passing centrally through the first and second mold mounting surfaces; (d) a first rail and a second rail extending parallel to, and on either side of, the machine axis, the first and second rails disposed at a rail elevation below the machine axis, the second platen slidably coupled to the first and second rails and translatable toward and away from the first platen between mold-closed and mold-open positions; (e) an access envelope having a generally rectangular prismatic shape extending axially between the first and second mold mounting surfaces, laterally between vertical mold mounting surface side edges of each of the first and second mold mounting surfaces, and vertically downward from an elevation of the mold mounting surface upper edge of the first and second mold mounting surfaces to an elevation at least as low as the machine axis; (f) first and second active force-exertion members spaced laterally apart from each other and coupled to the second platen, each of the first and second active force-exertion members exerting a clamping force along a respective first and second force application axis for clamping the first and second platens together when in the mold-closed position, each first and second force application axis parallel to and vertically below the rail elevation, wherein the access envelope is unobstructed by each of first and second active force exertion members; and (g) first and second passive force-reaction members coupled to the first and second platens for resisting separation of upper portions of the first and second mold mounting surfaces during exertion of the clamping force, the upper portions defined by portions of the mold mounting surfaces at an elevation above the rail elevation, each of the first and second passive force reaction members disposed below the rail elevation, wherein the access envelope is unobstructed by each of the first and second passive force reaction members.

In some examples, the access envelope extends vertically downward from the elevation of the mold mounting surface upper edge of the first and second mold mounting surfaces to the rail elevation.

In some examples, the first and second passive force reaction members comprise a first stabilizer beam and a second stabilizer beam, respectively, the first and second stabilizer beams extending parallel to each other and to the machine axis, each stabilizer beam having a beam length extending between a beam first end and a beam second end, each beam having a beam height extending vertically between a beam lower surface and a beam upper surface, and each beam having a beam a beam thickness extending laterally between opposed side faces. In some examples, the first platen is fixed to the first and second stabilizer beams proximate the respective beam first ends. In some examples, the first rail is fixed to the beam upper surface of the first stabilizer beam, and the second rail is fixed to the beam upper surface of the second stabilizer beam.

In some examples, each stabilizer beam is sized to counteract a moment load exerted on the stabilizer beam in reaction to application of the clamping force, the moment load exerting a tensile force along an upper portion of each stabilizer beam adjacent the beam upper surface, and exerting a compressive force along a lower portion of each stabilizer beam adjacent the beam lower surface. In some examples, the beam height is at least 75 percent of a mold mounting surface height, the mold mounting surface height extending vertically between a mold mounting surface upper edge and a mold mounting surface lower edge of each of the opposed first and second mold mounting surfaces. In some examples, the beam thickness is at least 50 mm.

In some examples, each of the first and second active force-exertion members comprises a clamp actuator coupled to a tie bar, the tie bar extending from the first platen and engageable with the second platen for exerting a clamp force across the first and second platens when in the mold-closed position, each tie bar extending along a respective tie bar axis parallel to the machine axis and at an elevation below the rail elevation.

Some examples include a locking device associated with each tie bar and mounted in the second platen, each locking device movable between a locked position for transferring axial force from the tie bar to the second platen during clamp-up, and an unlocked position in which the second platen is axially translatable relative to the tie bar, for movement between the mold open and mold closed positions.

Some examples include a platen stroke drive for translating the second platen between the mold-open and mold-closed positions, the platen stroke drive separate from the first and second active force exertion members.

According to some aspects, a method of clamping together platens of a two-platen injection molding machine, comprises (a) exerting a vertically offset compressive force across first and second platens by stretching first and second tie bars extending between and coupled to the first and second platens, the first and second platens oriented parallel to each other and at an elevation below a vertical midpoint of respective first and second mold mounting surfaces of the first and second platens, the vertically offset compressive force creating a moment load drawing lower portions of the first and second platens together more tightly than upper portions of the first and second platens; and (b) using first and second stabilizer beams to counteract the moment load and urge the upper portions of the first and second platens together more tightly, the first and second stabilizer beams coupled to the first and second platens at an elevation below the vertical midpoint of the first and second mold mounting surfaces, and the first and second stabilizer beams having a beam height and a beam thickness sized to resist tensile forces along respective upper surfaces of the first and second stabilizer beams and to resist compressive forces along respective lower surfaces of the first and second stabilizer beams.

Some examples include, prior to step (a), sliding the second platen along first and second rails mounted to the respective upper surfaces of the first and second stabilizer beams to translate the second platen from a mold open position distal the first platen to a mold closed position proximate the first platen.

According to some aspects, a two-platen injection molding machine includes a clamp apparatus. The clamp apparatus of the machine includes a first platen having a first mold mounting surface for affixing a first mold half thereto, and a second platen having a second mold mounting surface for affixing a second mold half thereto. The second mold mounting surface is directed toward the first mold mounting surface. A machine axis passes through respective centerpoints of each mold mounting surface.

The clamp apparatus includes a first rail and a second rail extending parallel to each other and to the machine axis. The first and second rails are disposed at a rail elevation offset vertically below the machine axis by a rail offset. The second platen is slidably coupled to the first and second rails and translatable toward and away from the first platen between mold-closed and mold-open positions.

The clamp apparatus further comprises, in some examples, at least one force transfer member associated with urging the mold halves tightly together so that, for example, the mold does not flash during injection. The at least one force transfer member can take the form of a force-exertion member and/or a force reaction-member. In some examples, at least one force-exertion member is coupled to the second platen, each of the at least one force-exertion member exerting a clamping force along a force application axis for clamping the first and second platens together when in the mold-closed position, each force application axis parallel to and offset vertically below the machine axis.

In some examples, at least one force-reaction member is coupled to the first and second platens for resisting separation of upper portions of the first and second mold mounting surfaces during exertion of the clamping force, the upper portions defined by portions of the mold mounting surfaces at an elevation above the machine axis, each of the at least one force reaction member disposed below the machine axis.

In some examples, the clamp apparatus is free of any force transfer members extending between the first and second platens at an elevation above the machine axis.

In some examples, the clamp apparatus is free of any force transfer members extending between the first and second platens at an elevation above the first and second rails.

In some examples, the at least one force-reaction member comprises a first stabilizer beam and a second stabilizer beam extending parallel to each other and to the machine axis. Each beam has a beam length extending between a beam first end and a beam second end, and the first platen is fixed to the first and second beams proximate the respective beam first ends. The second platen is movably supported on the first and second beams and translatable toward and away from the first platen between the mold-closed and mold-open positions.

In some examples, each of the first and second mold mounting surfaces has a mold mounting surface height extending vertically between a mold mounting surface lower edge and a mold mounting surface upper edge.

In some examples, each beam has a beam height extending vertically between a beam lower surface and a beam upper surface, and the beam height is at least 65 percent of the mold mounting surface height. In some examples the beam height is at least 75 percent of the mold mounting surface height. In some examples, at least 75 percent of the mold mounting surface height is disposed at a higher elevation than the beam upper surface of the beams.

In some examples, the first rail is mounted atop the first beam and the second rail is mounted atop the second beam, and the second platen is supported on a front bearing block and a rear bearing block coupled to each rail. Each of the front and rear bearing blocks has an axial center point, and the axial center points of the front and rear bearing blocks are spaced axially apart by a bearing block spacing. In some examples, the bearing block spacing is at least 50% of the mold mounting surface height. In some examples, the bearing block spacing is at least 50% of a maximum stroke of the second platen.

In some examples, each of the first platen and the second platen has an upper platen portion extending above a beam upper surface of the beams, and a platen lower portion extending below the beam upper surface.

In some examples, each beam has a beam height extending vertically between a beam lower surface and a beam upper surface, and a beam thickness extending laterally between opposed side faces, wherein the beam thickness is at least 10 percent of the beam height. In some examples, the beam height is at least 375 mm and the beam thickness is at least 50 mm. In some examples, the beam thickness is at least 15 percent of the beam height.

In some examples, each of the at least one force-exertion member comprises a clamp actuator coupled to the second platen for effecting the translation of the second platen between the mold-open and mold-closed positions and for exerting a clamp force across the first and second platens when in the mold-closed position. In some examples, the clamp actuator comprises a first stage drive for translating the second platen between the mold-open and mold-closed positions, and a second stage drive for exerting the clamp force across the first and second platens.

In some examples, the clamp actuator comprises at least one rod member extending along a rod axis, the rod axis parallel to and at an elevation below the machine axis. In some examples, the clamp actuator exerts a tensile force on the rod member when exerting the clamp force across the first and second platens. In some examples, the rod axis is at an elevation below an upper surface of the first and second rails.

In some examples, each rod member comprises a ball screw, and the actuator includes a ball nut coupled to the ball screw, the ball nut rotatable relative to the ball screw for translating the second platen. In some examples, the ball screw is fixed to the second platen. In some examples, the ball nut is rotatably mounted in the first platen.

In some examples, the actuator includes a rotary drive having a hollow drive shaft for driving rotation of the ball nut, and the ball screw passes through the hollow drive shaft at least when the second platen is in the mold-closed position.

In some examples, the actuator comprises a hydraulic piston coupled to the ball nut, the hydraulic piston axially translatable from an unclamped position to a clamped position for exerting an axial force on the ball nut that stretches the ball screw. This exerts the clamp force across the first and second platens when the moving platen is in the mold-closed position.

In some examples, the actuator includes a rotary drive having a drive shaft, and the ball nut is rotationally locked to the drive shaft via a sliding coupling. The sliding coupling accommodates axial translation of the ball nut relative to the drive shaft when the piston moves from the unclamped position to the clamped position.

In some examples, the piston has a cylindrical hollow interior, the ball nut is rotatably supported in the hollow interior, and the ball screw extends axially through the ball nut. In some examples, the piston is slidably disposed in a cylinder housing formed within the first platen. In some examples, the piston is rotationally locked relative to the first platen.

In some examples, each of the at least one force-exertion member comprises a clamp actuator coupled to the second platen for exerting a clamp force across the first and second platens when in the mold-closed position. In some examples, the clamp actuator comprises at least one rod member extending along a rod axis, the rod axis parallel to and at an elevation below the machine axis. In some examples, each rod member comprises a tie bar and a locking device is associated with each tie bar for selectively locking and unlocking the second platen to the tie bar. In some examples, each clamp actuator comprises a cylinder housing at least partially in the first platen, and a hydraulic piston fixed to the tie bar and slidable within the cylinder housing from an unclamped position to a clamped position for exerting the clamp force.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of an example injection molding machine;

FIG. 2 is a cross-sectional view of a clamp apparatus of the machine of FIG. 1, taken along line 2-2 of FIG. 1;

FIG. 3 is a cross-sectional view of a portion of the clamp apparatus of FIG. 2, taken along line 3-3 of FIG. 2;

FIG. 4 is an enlarged view of a portion of FIG. 2, showing an actuator portion of the clamp apparatus in a mold open condition;

FIG. 5 is an enlarged view like that of FIG. 4, but showing the actuator portion in a mold closed condition;

FIG. 6A is a perspective view from an operator side of an injection apparatus of the machine of FIG. 1;

FIG. 6B is a perspective view from a non-operator side of the injection apparatus of FIG. 6A;

FIG. 7 is an elevation view taken from the operator side of another example injection molding machine;

FIG. 8 is a top view of a portion of the machine of FIG. 7;

FIG. 9 is a perspective view taken from the operator side of portions of the machine of FIG. 7;

FIG. 9A shows a portion of FIG. 9, and a schematic illustration of an access envelope between platens of the machine of FIG. 9;

FIG. 10 is a cross-sectional view of a portion of the machine of FIG. 7, taken along line 10-10 in FIG. 8;

FIG. 10A is an enlarged view of a portion of FIG. 10;

FIG. 11 is a cross-sectional view of portions of the machine of FIG. 7, taken along line 11-11 in FIG. 8;

FIG. 12 is a cross-sectional view of portions of the machine of FIG. 7, taken along line 12-12 in FIG. 8; and

FIG. 13 is a cross-sectional view of portions of the machine of FIG. 7, taken along line 13-13 in FIG. 8.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

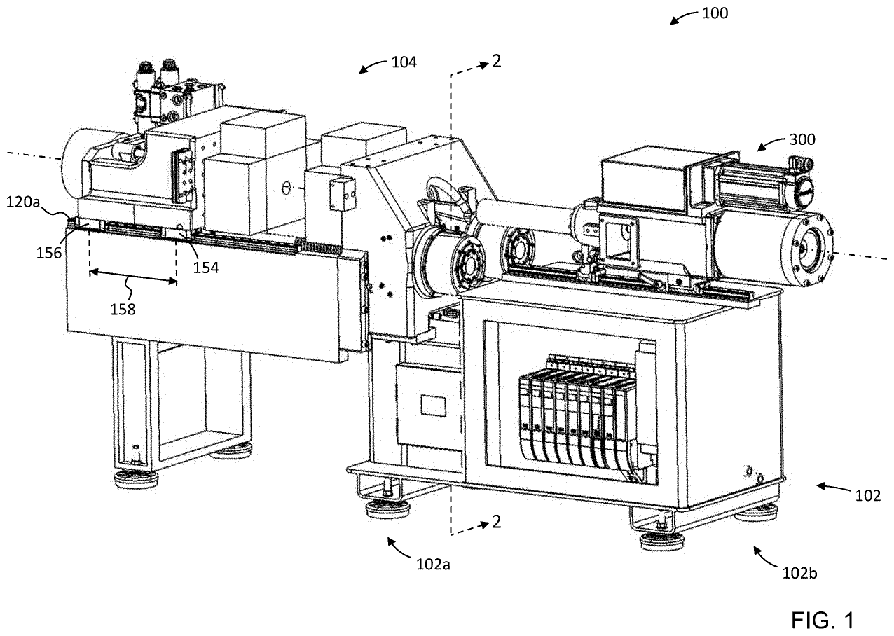

Referring to FIG. 1, an example of an injection molding machine 100 includes a base 102 and a clamp apparatus 104 supported by a clamp support portion 102a of the base 102. In the example illustrated, the clamp apparatus 104 is a two-platen, tiebarless clamp apparatus.

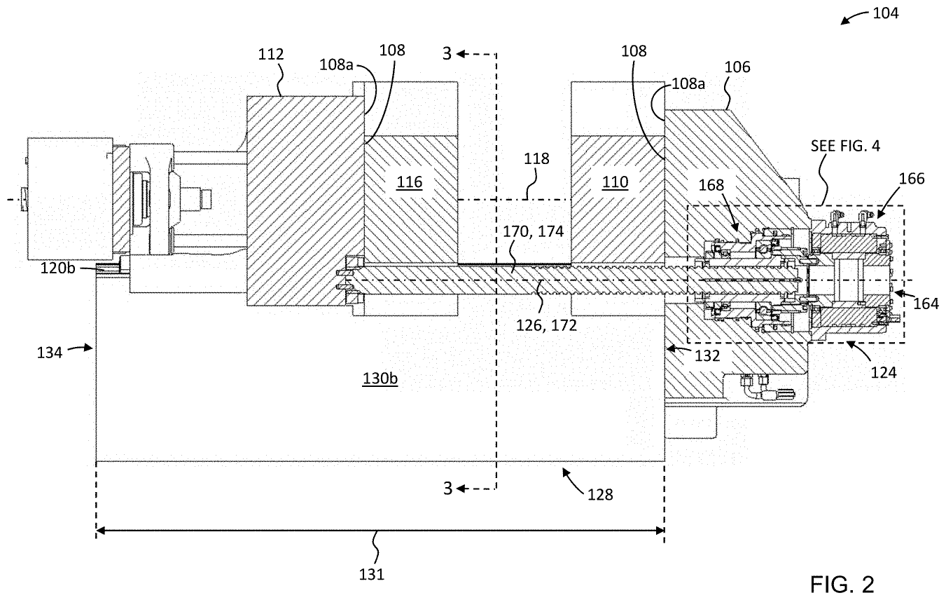

Referring to FIG. 2, in the example illustrated, the clamp apparatus 104 includes a first platen 106 (also referred to as stationary platen 106) having a mold mounting surface 108 (also referred to as the first mold mounting surface) for affixing a first mold half 110 thereto, and a second platen 112 having another mold mounting surface 108 (also referred to as the second mold mounting surface) for affixing a second mold half 116 thereto. In some examples, affixing a mold half to a respective mold mounting surface can include mounting a hot runner to the mold mounting surface and mounting the mold half to the hot runner. The mold mounting surface 108 of the first platen 106 is directed toward the mold mounting surface 108 of the second platen 112. A machine axis 118 passes centrally through the first and second mold mounting surfaces. In the example illustrated, the machine axis 118 is oriented generally horizontally, and passes through respective centerpoints of each mold mounting surface 108.

Referring to FIG. 3, in the example illustrated, the clamp apparatus 104 includes a first rail 120a and a second rail 120b extending parallel to each other and to the machine axis 118. The first and second rails 120a, 120b are disposed at a rail elevation offset vertically below the machine axis 118 by a rail offset 122. The second platen 112 is slidably coupled to the first and second rails 120a, 120b and translatable toward and away from the first platen 106 between a mold-open position (shown in FIG. 1) and a mold-closed position. In the example illustrated, the first and second rails 120a, 120b are disposed on either side of the machine axis 118. Specifically, the first rail 120a extends along an operator side of the machine, and the second rails is laterally offset from the first rail and extends along a non-operator side of the machine.

Referring to FIG. 2, in the example illustrated, the clamp apparatus 104 includes at least one force-exertion member 124 coupled to the second platen 112. Each of the at least one force-exertion member 124 exerts a clamping force along a force application axis 126 for clamping the first and second platens 106, 112 together when in the mold-closed position. Each force application axis 126 is parallel to and offset vertically below the machine axis 118.

Referring still to FIG. 2, in the example illustrated, the clamp apparatus 104 includes at least one force-reaction member 128 coupled to the first and second platens 106, 112 for resisting separation of upper portions 108a of the mold mounting surfaces 108 during exertion of the clamping force. The upper portions 108a are defined by portions of the mold mounting surfaces 108 at an elevation above the machine axis 118. Each of the at least one force-reaction member 128 is disposed below the rail elevation.

In the example illustrated, the clamp apparatus 104 is free of any force transfer members extending between the first and second platens 106, 112 at an elevation above the machine axis 118. In the example illustrated, the clamp apparatus 104 is free of any force transfer members extending between the first and second platens 106, 112 at an elevation above the first and second rails 120a, 120b. The absence of force transfer members extending between the platens at an elevation above the machine axis 118, and above the rails 120a, 120b can provide easier access to the mold area between the platens for automation when loading or unloading parts into the molds, when installing or removing mold halves from the platens, and/or when performing maintenance activities on the machine.

Referring to FIG. 3, in the example illustrated, the at least one force-reaction member 128 comprises a first stabilizer beam 130a and a second stabilizer beam 130b extending parallel to each other and to the machine axis 118. Referring to FIG. 2, each stabilizer beam 130a, 130b has a beam length 131 extending between a beam first end 132 and a beam second end 134. In the example illustrated, the beam length 131 is approximately 1200 mm. The first platen 106 is fixed to the first and second stabilizer beams 130a, 130b proximate the respective beam first ends 132. In the example illustrated, an axial endface at the beam first end 132 of each beam 130a, 130b is mounted against a front surface of the first platen 106. The second platen 112 is movably supported on the first and second stabilizer beams 130a, 130b and translatable along the machine axis 118 toward and away from the first platen 106 between the mold-closed and mold-open positions.

Referring to FIG. 3, in the example illustrated, each of the mold mounting surfaces 108 has a mold mounting surface height 136 extending vertically between a mold mounting surface lower edge 138 and a mold mounting surface upper edge 140. In the example illustrated, the mold mounting surface height 136 is about 500 mm.

In the example illustrated, each stabilizer beam 130a, 130b has a beam height 142 extending vertically between a beam lower surface 144 and a beam upper surface 146 opposite the beam lower surface 144. The beam height 142 can be at least 75 percent of the mold mounting surface height 136. In the example illustrated, the beam height 142 is about 400 mm. In the example illustrated, each stabilizer beam 130a, 130b has a beam thickness 148 extending laterally between opposed side faces 150. The beam thickness 148 can be at least 10 percent of the beam height 142. In some examples, the beam thickness 148 can be at least 40 mm. In the example illustrated, the beam thickness is about 55 mm.

In the example illustrated, at least 75 percent of the mold mounting surface height 136 can be disposed at a higher elevation than the beam upper surface 146. In the example illustrated, at least 80 percent of the mold mounting surface height 136 is disposed at a higher elevation than the beam upper surface 146.

Referring still to FIG. 3, in the example illustrated, the first rail 120a is mounted atop the first stabilizer beam 130a and the second rail 120b is mounted atop the second stabilizer beam 130b. The second platen 112 is supported on bearing blocks 152 coupled to the rails 120a, 120b. Referring to FIG. 1, in the example illustrated, the bearing blocks 152 include a front bearing block 154 and a rear bearing block 156 coupled to each rail 120a, 120b. Each of the front bearing block 154 and the rear bearing block 156 has an axial center point, and the axial center points of the front and rear bearing blocks 154, 156 are spaced axially apart by a bearing block spacing 158. The bearing block spacing 158 can be at least one of: (i) at least 50% of the mold mounting surface height 136; and (ii) at least 50% of a maximum stroke of the second platen 112, which maximum stroke is defined by movement between a maximum mold-open position (also called maximum daylight position) and a minimum mold-closed position (corresponding to the mold closed-position with a mold of minimum mold height). In the example illustrated, the bearing block spacing 158 is about 375 mm.

Referring to FIG. 3, in the example illustrated, each of the first platen 106 and the second platen 112 has a platen upper portion 160 extending above the beam upper surface 146, and a platen lower portion 162 extending below the beam upper surface 146.

Referring to FIG. 2, in the example illustrated, each of the at least one force-exertion member 124 comprises a clamp actuator 164 coupled to the second platen 112 for effecting the translation of the second platen 112 between the mold-open and mold-closed positions and for exerting a clamp force across the first and second platens 106, 112 when in the mold-closed position. In the example illustrated, the clamp actuator 164 comprises a first stage drive 166 (also referred to as a platen-stroke drive 166) for translating the second platen 112 between the mold-open and mold-closed positions, and a second stage drive 168 (also referred to as a clamp drive 168) for exerting a clamp force across the first and second platens 106, 112 when in the mold-closed position.

In the example illustrated, the clamp actuator 164 comprises at least one rod member 170 extending along a rod axis 172. The rod axis 172 is parallel to and at an elevation below the machine axis 118. In the example illustrated, the rod axis 172 is at an elevation below an upper surface of the first and second rails 120a, 120b. The actuator 164 exerts a tensile force on the rod member 170 when exerting the clamp force across the platens 106, 112.

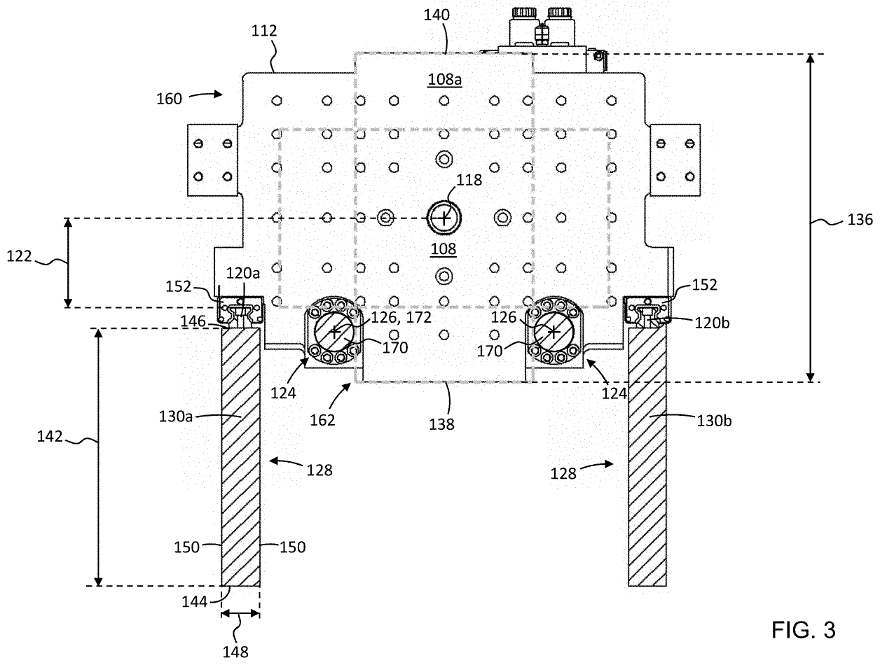

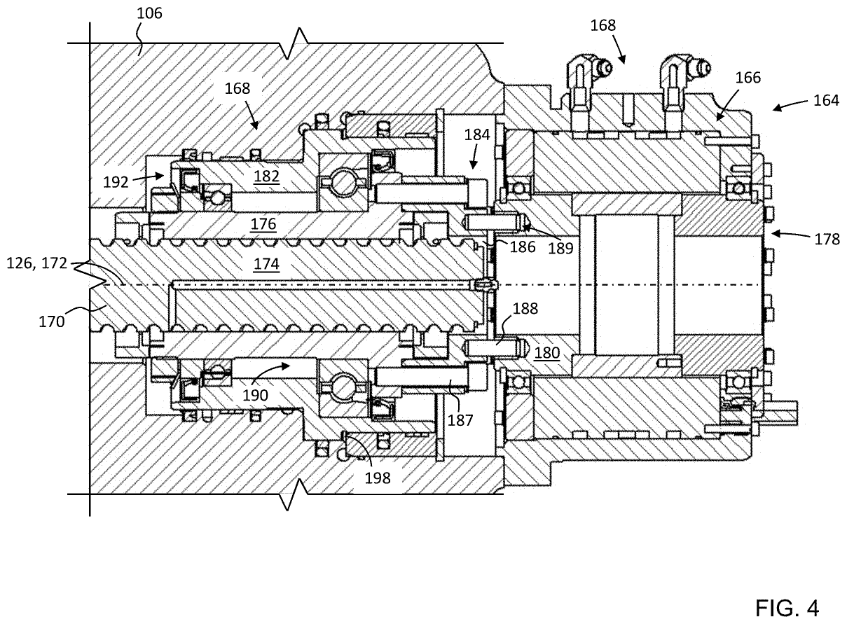

Referring to FIG. 4, in the example illustrated, each rod member 170 comprises a ball screw 174. The actuator 164 further includes a ball nut 176 coupled to the ball screw 174. The ball nut 176 is rotatable relative to the ball screw 174 for translating the second platen 112. In the example illustrated, the ball screw 174 is fixed to the second platen 112 (FIG. 2), and the ball nut 176 is rotatably mounted in the first platen 106. In the example illustrated, the ball screw 174 is non-rotating, which can facilitate providing internal cooling fluid through delivery and evacuation conduits extending lengthwise within the ball screw 174.

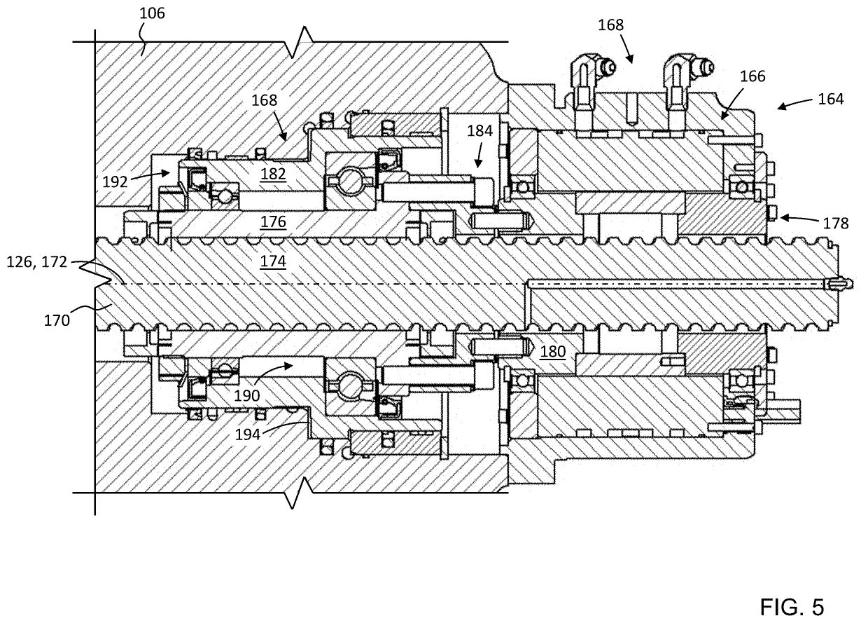

In the example illustrated, the first stage drive 166 comprises a rotary drive 178 for driving rotation of the ball nut 176. In the example illustrated, the rotary drive 178 includes a hollow shaft motor having a hollow drive shaft 180 coaxial with and rotationally locked to the ball nut 176 for driving rotation thereof. Referring to FIG. 5, in the example illustrated, the ball screw 174 passes through the ball nut 176 and the hollow drive shaft 180 when the second platen 112 is in the mold-closed position.

In the example illustrated, the second stage drive 168 comprises a hydraulic piston 182 coupled to the ball nut 176. The hydraulic piston 182 is axially translatable from an unclamped position (shown in FIG. 4) to a clamped position (shown in FIG. 5) for exerting an axial force on the ball nut 176 that stretches the ball screw 174 to exert the clamp force across the first and second platens 106, 112.

In the example illustrated, the ball nut 176 is rotationally locked to the drive shaft 180 via a sliding coupling 184. Referring to FIG. 4, in the example illustrated, the sliding coupling 184 includes a torque transfer ring 186 fixed to a rear end face of the ball nut (via bolts 187). The torque transfer ring 186 is, in the example illustrated, axially and rotationally fixed relative to the ball nut 176. The sliding coupling 184 further includes at least one torque transfer member 188 extending between the shaft 180 of the hollow motor and the torque transfer ring 186. Each of the at least one torque transfer member 188 is rotationally locked relative to the shaft 180 and to the transfer ring 186, and axially slidable relative to at least one of the shaft 180 and the transfer ring 186.

In the example illustrated, the torque transfer members 188 comprise a plurality of drive pins, each oriented parallel to the machine axis 118, fixed to the torque transfer ring 186, and protruding towards the drive shaft 180 of the hollow motor. The drive shaft 180 comprises a plurality of bores 189, each bore 189 receiving a portion of a respective drive pin in sliding fit.

In the example illustrated, the sliding coupling 184 accommodates axial translation of the ball nut 176 relative to the drive shaft 180 when the piston 182 moves from the unclamped position to the clamped position (i.e. when the ball screw is stretched by the force exerted by the piston 182). In the example illustrated, the piston 182 has a cylindrical hollow interior 190, and the ball nut 176 is rotatably supported in the hollow interior 190. In the example illustrated, the piston 182 is slidably disposed in a cylinder housing 192 formed within the first platen 106, and the piston 182 is rotationally locked relative to the first platen 106.

Referring to FIG. 4, in operation, the piston 182 is in the unclamped position when the second platen 112 is moved from the mold-open position to the mold-closed position (i.e. when the ball nut 176 is rotated to translate the ball screw 174 and move the second platen 112 to the mold-closed position). Referring to FIG. 5, once the mold is closed, an annular clamp chamber 194 extending axially between opposed shoulder surfaces of the piston 182 and the cylinder housing 192 is pressurized with fluid to urge the piston 182 to the clamped position. A brake can be engaged prior to pressurization of the chamber 194 to inhibit rotation of the ball nut 176 when the piston 182 is urged axially to the clamped position. As the ball nut 176 is urged towards the shaft 180, the drive pins 188 slide further into the bores 189 of the drive shaft 180, and the gap between the torque transfer ring and the shaft 180 decreases, but a reduced gap remains even at full clamp force. This configuration can help ensure that the motor is isolated from the axial clamp force exerted by the clamp piston.

After injection, pressure in the clamp chamber 194 is relieved, the brake can be released, and a reset chamber 198 (FIG. 4) is pressurized to move the piston 182 back to the unclamped position.

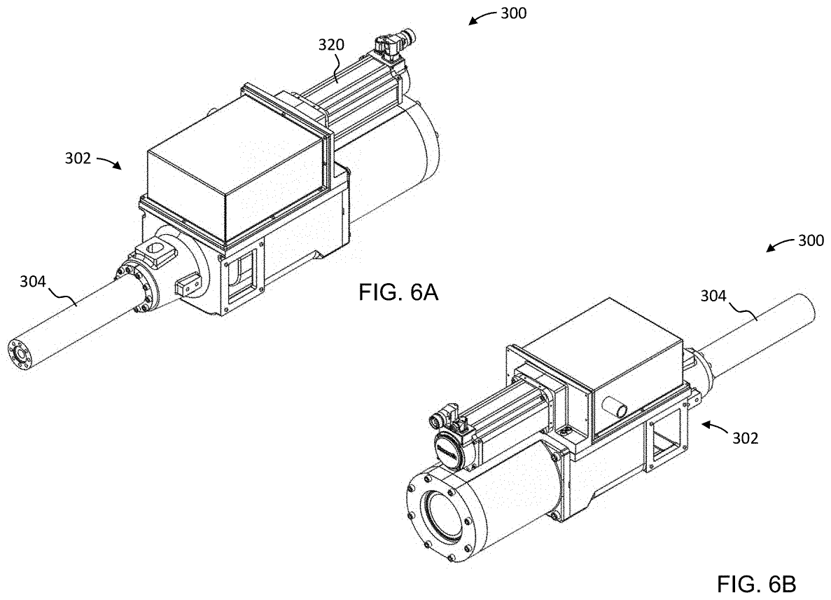

Referring again to FIG. 1, in the example illustrated, the machine 100 includes an injection apparatus 300 supported by an injection support portion 102b of the base 102. Referring to FIGS. 6A and 6B, in the example illustrated, the injection apparatus 300 includes a housing 302 and a barrel 304 fixed to and extending from a front end of the housing 302 for receiving a plasticizing screw. A gear box is slidably supported in the housing 302. A rotary drive 320 is mounted to the housing 302. The rotary drive includes a drive shaft rotationally locked to an input shaft of the gear box for driving rotation thereof.

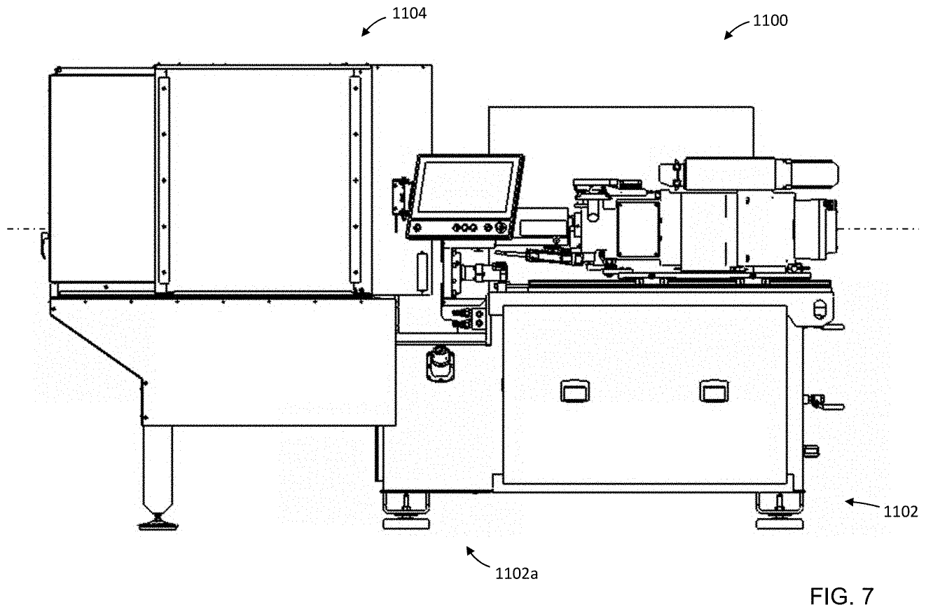

Referring to FIG. 7, an example of an injection molding machine 1100 is illustrated. The machine 1100 is similar to the machine 100 and like features are indicated using like reference characters, incremented by 1000. In the example illustrated, the machine 1100 includes a base 1102 and a clamp apparatus 1104 supported by a clamp support portion 1102a of the base 1102.

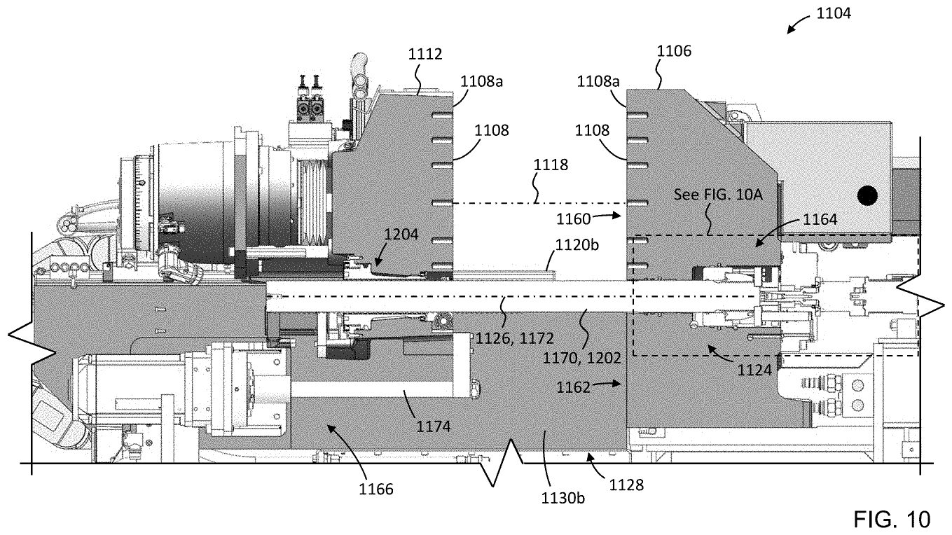

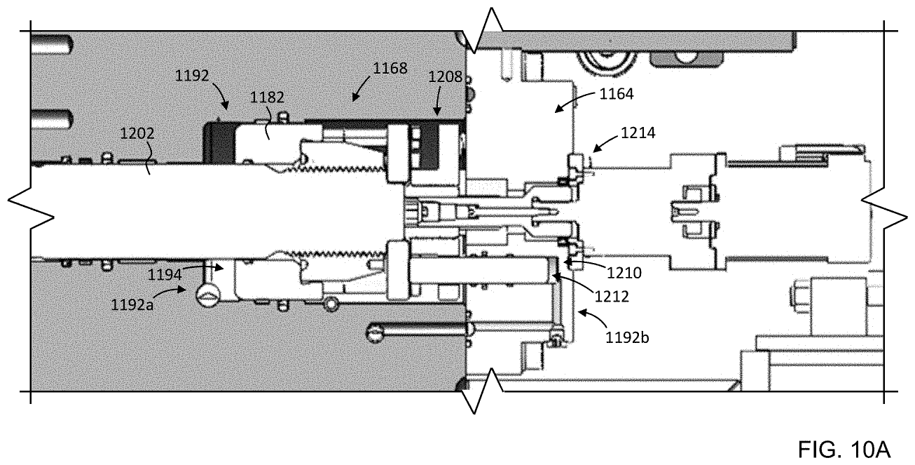

Referring to FIG. 10, in the example illustrated, the clamp apparatus 1104 includes a first platen 1106 having a mold mounting surface 1108 for affixing a first mold half thereto, and a second platen 1112 having another mold mounting surface 1108 for affixing a second mold half 1116 thereto. A machine axis 1118 passes through respective centerpoints of each mold mounting surface 1108.

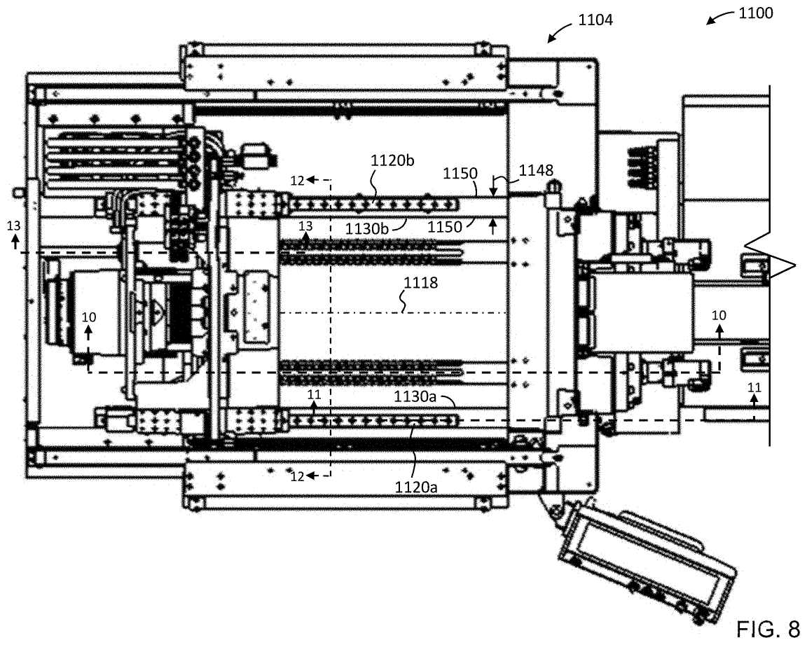

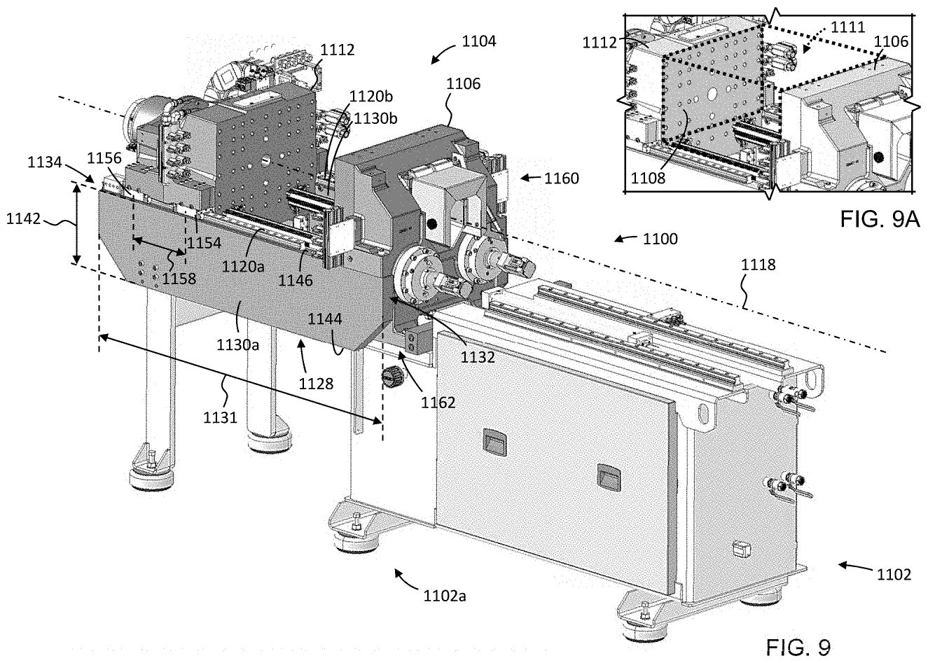

Referring to FIG. 8, in the example illustrated, the clamp apparatus 1104 includes a first rail 1120a and a second rail 1120b extending parallel to each other and to the machine axis 1118. Referring to FIG. 10, in the example illustrated, the first and second rails 1120a, 1120b are disposed at a rail elevation offset vertically below the machine axis 1118. The second platen 1112 is slidably coupled to the first and second rails 1120a, 1120b and translatable toward and away from the first platen 1106 between a mold-open position (shown in FIG. 9) and a mold-closed position.

Referring to FIG. 10, in the example illustrated, the clamp apparatus 1104 includes at least one force-exertion member 1124 coupled to the first and second platens 1106, 1112. Each of the at least one force-exertion member 1124 is an active force-exertion member that can be actuated to exert a clamping force along a force application axis 1126 for clamping the first and second platens 1106, 1112 together when in the mold-closed position. Each force application axis 1126 is parallel to and offset vertically below the machine axis 1118. This configuration facilitates providing an access envelope 1111 (see FIG. 9A) that is unobstructed by the force exertion members.

More specifically, the access envelope 1111 has a generally rectangular prismatic shape extending axially between the first and second mold mounting surfaces, and extending laterally between vertical mold mounting surface side edges of each of the first and second mold mounting surfaces, and extending vertically downward from an elevation of the mold mounting surface upper edge of the first and second mold mounting surfaces to an elevation at least as low as the machine axis. In the example illustrated, the access envelope extends vertically downward to the rail elevation. The side faces and top face of the access envelope are, in the example illustrated, unobstructed by, and clear of, the force exertion members. This can facilitate easier access to the mold area for part insertion or removal, for mold changes, maintenance, or other purposes.

In the example illustrated, the clamp apparatus 1104 includes at least one force-reaction member 1128 coupled to the first and second platens 1106, 1112 for resisting separation of opposed upper portions 1108a of the mold mounting surfaces 1108 of the first and second platens during exertion of the clamping force. The force-reaction members are, in the example illustrated, passive force reaction members that are not actuatable or energizable by a power source. Each of the at least one passive force-reaction member 1128 is disposed below the rail elevation. This configuration facilitates providing the access envelope 1111 in a way that is unobstructed by the force reaction members.

In the example illustrated, the clamp apparatus 1104 is free of any force transfer members extending between the first and second platens 1106, 1112 at an elevation above the machine axis 1118, and is free of any force transfer members extending between the first and second platens 1106, 1112 at an elevation above the first and second rails 1120a, 1120b.

Referring to FIG. 9, in the example illustrated, the at least one force-reaction member 1128 comprises a first stabilizer beam 1130a and a second stabilizer beam 1130b (FIG. 8) extending parallel to each other and to the machine axis 1118. Each stabilizer beam 1130a, 1130b has a beam length 1131 extending between a beam first end 1132 and a beam second end 1134, a beam height 1142 extending vertically between a beam lower surface 1144 and a beam upper surface 1146 opposite the beam lower surface 1144, and a beam thickness 1148 (FIG. 8) extending laterally between opposed side faces 1150 (FIG. 8). In the example illustrated, the beam height 1142 is about 330 mm, and the beam thickness 1148 is about 57 mm.

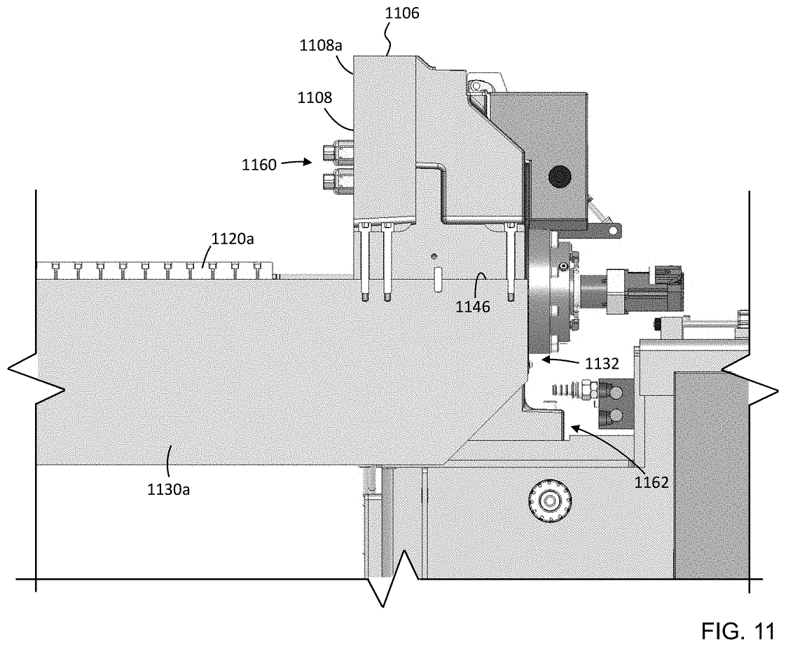

Referring to FIG. 11, in the example illustrated, the first platen 1106 is fixed to the first and second stabilizer beams 1130a, 1130b proximate the beam first end 1132 of the beams 1130a, 1130b. In the example illustrated, a portion of the beam upper surface 1146 at the beam first end 1132 of each beam 1130a, 1130b is mounted against an underside surface of the first platen 1106. In the example illustrated, each of the first platen 1106 and the second platen 1112 has a platen upper portion 1160 extending above the beam upper surface 1146, and a platen lower portion 1162 extending below the beam upper surface 1146.

Referring to FIG. 9, in the example illustrated, the second platen 1112 is movably supported on the first and second stabilizer beams 1130a, 1130b and translatable along the machine axis 1118 toward and away from the first platen 1106 between the mold-closed and mold-open positions.

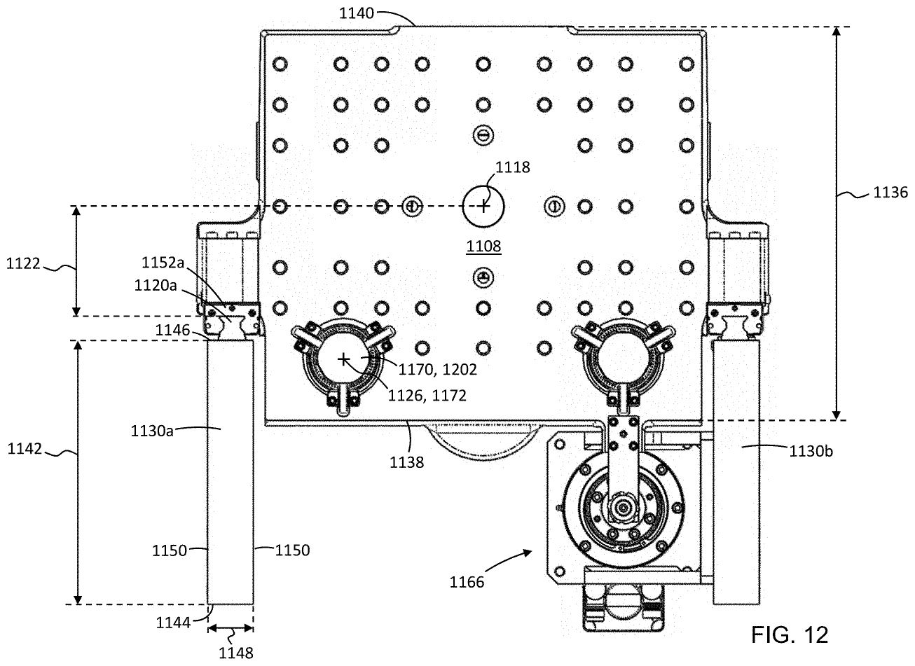

Referring to FIG. 12, in the example illustrated, each of the mold mounting surfaces 1108 has a mold mounting surface height 1136 extending vertically between a mold mounting surface lower edge 1138 and a mold mounting surface upper edge 1140. The beam height 1142 is at least 65% of the mold mounting surface height 1136. The beam thickness 1148 is at least 15% of the beam height 1142. At least 65% of the mold mounting surface height 1136 is disposed at a higher elevation than the beam upper surface 1146. In the example illustrated, the mold mounting surface height 1136 is approximately 450 mm.

Referring to FIG. 9, in the example illustrated, the first rail 1120a is mounted atop the first stabilizer beam 1130a and the second rail 1120b is mounted atop the second stabilizer beam 1130b. The second platen 1112 is supported on bearing blocks coupled to the rails 1120a, 1120b. In the example illustrated, the bearing blocks include a front bearing block 1154 and a rear bearing block 1156 coupled to each rail 1120a, 1120b. Each of the front bearing block 1154 and the rear bearing block 1156 has an axial center point, and the axial center points of the front and rear bearing blocks 1154, 1156 are spaced axially apart by a bearing block spacing 1158. The bearing block spacing 1158 can be at least one of: (i) at least 50% of the mold mounting surface height 1136; and (ii) at least 50% of a maximum stroke of the second platen 1112. In the example illustrated, the bearing block spacing 1158 is about 280 mm.

Referring to FIG. 10, in the example illustrated, each of the at least one force-exertion member 1124 comprises a clamp actuator 1164 coupled to the second platen 1112 for exerting a clamp force across the first and second platens 1106, 1112 when in the mold-closed position.

In the example illustrated, the clamp actuator 1164 comprises at least one rod member 1170 extending along a respective rod axis 1172 that is parallel to and at an elevation below the machine axis 1118. In the example illustrated, the rod axis 1172 is at an elevation below an upper surface of the first and second rails 1120a, 1120b. The clamp actuator 1164 exerts a tensile force on the rod member 1170 when exerting the clamp force across the platens 1106, 1112.

In the example illustrated, each rod member 1170 comprises a tie bar 1202. In the example illustrated, a locking device 1204 is associated with each tie bar 1202 for selectively locking and unlocking the second platen 1112 to the tie bars 1202. In the example illustrated, each locking device 1204 is mounted to the second platen 1112 and has a plurality of tie bar engagement surfaces movable between locked and unlocked positions. In the locked position, the engagement surfaces are positioned for engagement with tie bar teeth of the tie bar 1202 to lock the tie bar 1202 to the second platen 1112. In the unlocked position, the engagement surfaces are clear of the tie bar teeth to permit axial translation of the second platen 1112 relative to the tie bar 1202. In the example illustrated, each locking device 1204 comprises a rotary style locking device and the engagement surfaces are rotatable between the locked and unlocked positions.

Referring to FIG. 10A, in the example illustrated, each clamp actuator 1164 comprises a clamp drive 1168 for exerting a clamp force across the first and second platens 1106, 1112 when in the mold-closed position. In the example illustrated, the clamp drive 1168 comprises a cylinder housing 1192 at least partly in the first platen 1106 and having an inner end 1192a and an outer end 1192b opposite the inner end 1192a. The clamp drive 1168 further includes a hydraulic piston 1182 fixed to the tie bar 1202 and slidable within the cylinder housing 1192 from an unclamped position to a clamped position for exerting an axial force that stretches the tie bar 1202 to exert the clamp force across the first and second platens 1106. In the example illustrated, the unclamped position can correspond to a meshing position for interference-free movement of the engagement surfaces of the locking device 1204, between the locked and unlocked positions, relative to the tie bar teeth. In the example illustrated, the piston 1182 is further movable to a mold-break position for urging apart the mold halves 1108.

In the example illustrated, the cylinder housing 1192 provides a clamp chamber 1194 on a first side of the piston 1182 toward the inner end 1192a of the housing 1192 for urging the piston 1182 to the clamped position when pressurized, a return device 1208 on an opposite second side of the piston 1182 toward the outer end 1192b of the housing 1192 for pushing the piston 1182 back toward the meshing position when pressure in the clamp chamber 1194 is relieved, and a mold break actuator 1210 on the second side of the piston 1182 for pushing the piston 1182 from the clamped and/or meshing position to the mold break position. In cases where a mold break force is required or desired, before unlocking the locking device 1204 after an injection cycle, a mold break chamber 1212 of the mold break actuator 1210 can be pressurized to exert a strong opening force (mold break force) to push the second platen 1112 away from the first platen 1106 and urge apart the mold halves 1108. In the example illustrated, the clamp drive 1168 further includes a mold-height adjustment mechanism 1214 for adjusting an axial location of the meshing position to accommodate different mold heights.

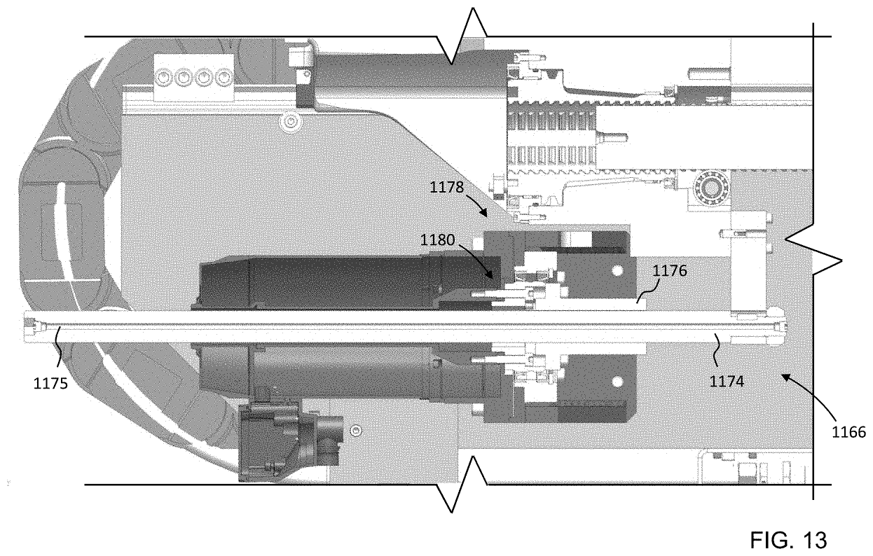

Referring to FIG. 10, in the example illustrated, the machine 1100 further includes a platen-stroke drive 1166 for translating the second platen 1112 between the mold-open and mold-closed positions. Referring to FIG. 13, in the example illustrated, the platen-stroke drive 1166 is separate from the force-exertion member 1124, and includes a ball nut 1176 and a ball screw 1174 coupled to the ball nut 1176. In the example illustrated, the ball nut 1176 is axially fixed relative to the rails 1120 (i.e. axially fixed relative to the base 1102), and the ball screw 1174 is axially fixed relative to the second platen 1112. The ball nut 1176 is rotatable relative to the ball screw 1174 for translating the second platen 1112 along the machine axis 1118. In the example illustrated, the ball screw 1174 is non-rotating relative to the rails, and the ball nut is non-translating relative to the rails. The ball screw 1174 includes an internal cooling conduit 1175 extending lengthwise within the ball screw 1174 to conduct a cooling fluid for removing heat from the ball screw 1174. Having a non-rotating ball screw 1174 can simplify the connection of delivery and evacuation lines at either end of the internal conduit 1175.

In the example illustrated, the platen-stroke drive 1166 comprises a rotary drive 1178 for driving rotation of the ball nut 1176. In the example illustrated, the rotary drive 1178 includes a hollow shaft motor having a hollow drive shaft 1180 coaxial with and rotationally locked to the ball nut 1176 for driving rotation thereof. In the example illustrated, the ball screw 1174 passes through the ball nut 1176 and the hollow drive shaft 1180 when the second platen 1112 moves toward and is in the mold-open position.

In operation, the piston 1182 is in the unclamped position when the second platen 1112 is moved from the mold-open position to the mold-closed position (through rotation of the ball nut 1176 in a forward rotational direction for advancing the ball screw 1174 and the second platen 1112 toward the mold-closed position). This slides the second platen along first and second rails (mounted to the respective upper surfaces of the first and second stabilizer beams) to translate the second platen from the mold open position (distal the first platen) to the mold closed position (proximate the first platen).

Once the mold is closed, the clamp chamber 1194 is pressurized with fluid to urge the piston 1182 toward the outer end 1192b of the housing 1192 to the clamped position. This exerts a vertically offset compressive force across first and second platens by stretching first and second tie bars 1202 extending between and coupled to the first and second platens. The compressive force is offset vertically, at an elevation below a vertical midpoint of the respective first and second mold mounting surfaces of the first and second platens. The vertically offset compressive force create a moment load drawing lower portions of the first and second platens together more tightly than upper portions of the first and second platens. If not counteracted, this can result in mold flash between the mold halves along respective upper portions thereof.

However, in the example illustrated, the first and second stabilizer beams counteract the moment load and urge the upper portions of the first and second platens together more tightly. The first and second stabilizer beams, which are coupled to the first and second platens at an elevation below the vertical midpoint of the first and second mold mounting surfaces, each have a beam height and a beam thickness sized to resist tensile forces along respective upper surfaces of the first and second stabilizer beams and to resist compressive forces along respective lower surfaces of the first and second stabilizer beams.

After injection, pressure in the clamp chamber 1194 is relieved, and the return device 1208 pushes the piston 1182 back toward the inner end 1192a of the housing 1192 to the meshing position, under the force exerted by, for example, a plurality of springs of the return device 1208.

If no mold break force is required or desired, then once the piston 1182 is moved to the meshing position, the locking device 1204 is unlocked and the platen-stroke drive 1166 is energized to move the second platen 1112 to the mold-open position (through rotation of the ball nut 1176 in a reverse rotational direction for retracting the ball screw 1174 and the second platen 1112 to the mold-open position).

In cases where a mold break force is required or desired, then before unlocking the locking device 1204, the mold break actuator 1210 is energized (e.g. the chamber 1212 is pressurized) to push the piston 1182 toward the inner end 1192a of the housing 1192 to the mold break position, to exert the mold break force for urging apart the mold halves 1108. The clamp chamber 1194 is then pressurized to move the piston 1182 back toward the clamping position. Once the piston 1182 is moved past the meshing position, pressure in the clamp chamber 1194 is relieved, and the return device 1208 pushes the piston 1182 to the meshing position. The locking device 1204 is then unlocked and the platen-stroke drive 1166 is energized to move the second platen 1112 to the mold-open position.

1. A two-platen clamp apparatus for an injection molding machine, comprising:
a) a first platen having a first mold mounting surface for affixing a first mold half thereto, and a second platen having a second mold mounting surface for affixing a second mold half thereto, the second mold mounting surface directed toward the first mold mounting surface;
b) a horizontally oriented machine axis passing through respective centerpoints of each mold mounting surface;
c) a first rail and a second rail extending parallel to each other and to the machine axis, the first and second rails disposed at a rail elevation vertically below the machine axis; the second platen slidably coupled to the first and second rails and translatable toward and away from the first platen between mold-closed and mold-open positions;
d) at least one force-exertion member coupled to the second platen, each of the at least one force-exertion member exerting a clamping force along a force application axis for clamping the first and second platens together when in the mold-closed position, each force application axis parallel to and offset vertically below the machine axis; and
e) at least one force-reaction member coupled to the first and second platens for resisting separation of upper portions of the first and second mold mounting surfaces during exertion of the clamping force, the upper portions defined by portions of the mold mounting surfaces at an elevation above the machine axis, each of the at least one force reaction member disposed at an elevation below the machine axis.

2. The clamp apparatus of claim 1, wherein the clamp apparatus is free of any force transfer members extending between the first and second platens at an elevation above the first and second rails.

3. The clamp apparatus of claim 1, wherein the at least one force-reaction member comprises a first stabilizer beam and a second stabilizer beam extending parallel to each other and to the machine axis, each beam having a beam length extending between a beam first end and a beam second end, the first platen fixed to the first and second beams proximate the respective beam first ends, and the second platen movably supported on the second beams and translatable toward and away from the first platen between the mold-closed and mold-open positions, each beam having a beam height extending vertically between a beam lower surface and a beam upper surface.

4. The clamp apparatus of claim 3, wherein each of the first and second mold mounting surfaces has a mold mounting surface height extending vertically between a mold mounting surface lower edge and a mold mounting surface upper edge, and a mold mounting surface width extending laterally between spaced apart mold mounting surface side edges.

5. The clamp apparatus of claim 4, wherein the beam height is at least 75 percent of the mold mounting surface height.

6. The clamp apparats of claim 5, wherein each beam has a beam thickness extending laterally between opposed side faces, each beam thickness being at least 50 mm.

7. The clamp apparatus of claim 1, wherein each of the at least one force-exertion member comprises a clamp actuator coupled to at least the second platen for exerting a clamp force across the first and second platens when in the mold-closed position, the clamp actuator comprising a rod member extending along a rod axis, the rod axis parallel to the machine axis and at an elevation below the rails.

8. The clamp apparatus of claim 7, wherein the clamp actuator comprises a first stage drive for translating the second platen between the mold open and mold closed positions, and a second stage drive for exerting a clamp force across the first and second platens when in the mold closed position.

9. The clamp apparatus of claim 7, wherein the rod member comprises a ball screw, and wherein the actuator includes a ball nut rotatably coupled to each ball screw, each ball nut and respective ball screw rotatable relative to one another for urging translation of the moving platen and exerting the clamp load.

10. The clamp apparatus of claim 7, wherein each rod member comprises a tie bar extending between the first and second platens, the clamp actuator exerting a tensile force on the tie bar when exerting the clamp load across the platens.

11. The clamp apparatus of claim 10, further comprising a locking device associated with each tie bar and mounted in the second platen, each locking device movable between a locked position for transferring axial force from the tie bar to the second platen during clamp-up, and an unlocked position in which the second platen is axially translatable relative to the tie bar, for movement between the mold open and mold closed positions.

12. The clamp apparatus of claim 10, further comprising a platen stroke drive for translating the second platen between the mold-open and mold-closed positions, the platen stroke drive separate from the force exertion member.

13. The clamp apparatus of claim 12, wherein the platen stroke drive comprises a ball nut axially fixed relative to the rails, and a ball screw coupled to the ball nut, the ball screw axially and rotationally fixed relative to the second platen and translatable with the second platen upon rotation of the ball nut.

14. The clamp apparatus of claim 13, wherein the ball screw has an internal cooling conduit extending lengthwise within the ball screw for circulating a cooling fluid to remove heat from the ball screw.

15. A two-platen injection molding machine, comprising:
a) a base having a clamp support portion for supporting a clamp apparatus and an injection support portion for supporting an injection unit;
b) a first platen and a second platen supported by the clamp support portion of the base, the first platen having a first mold mounting surface for affixing a first mold half thereto, and the second platen spaced horizontally apart from the first platen and having a second mold mounting surface opposed to the first mold mounting surface for affixing a second mold half thereto;
c) a horizontally oriented machine axis passing centrally through the first and second mold mounting surfaces;
d) a first rail and a second rail extending parallel to, and on either side of, the machine axis, the first and second rails disposed at a rail elevation below the machine axis, the second platen slidably coupled to the first and second rails and translatable toward and away from the first platen between mold-closed and mold-open positions;
e) an access envelope having a generally rectangular prismatic shape extending axially between the first and second mold mounting surfaces, laterally between vertical mold mounting surface side edges of each of the first and second mold mounting surfaces, and vertically downward from an elevation of the mold mounting surface upper edge of the first and second mold mounting surfaces to an elevation at least as low as the machine axis;
f) first and second active force-exertion members spaced laterally apart from each other and coupled to the second platen, each of the first and second active force-exertion members exerting a clamping force along a respective first and second force application axis for clamping the first and second platens together when in the mold-closed position, each first and second force application axis parallel to and vertically below the rail elevation, wherein the access envelope is unobstructed by each of first and second active force exertion members; and
g) first and second passive force-reaction members coupled to the first and second platens for resisting separation of upper portions of the first and second mold mounting surfaces during exertion of the clamping force, the upper portions defined by portions of the mold mounting surfaces at an elevation above the rail elevation, each of the first and second passive force reaction members disposed below the rail elevation, wherein the access envelope is unobstructed by each of the first and second passive force reaction members.

16. The machine of claim 15, wherein the access envelope extends vertically downward from the elevation of the mold mounting surface upper edge of the first and second mold mounting surfaces to the rail elevation.

17. The machine of claim 15, wherein the first and second passive force reaction members comprise a first stabilizer beam and a second stabilizer beam, respectively, the first and second stabilizer beams extending parallel to each other and to the machine axis, each stabilizer beam having a beam length extending between a beam first end and a beam second end, each beam having a beam height extending vertically between a beam lower surface and a beam upper surface, and each beam having a beam a beam thickness extending laterally between opposed side faces.

18. The machine of claim 17, wherein the first platen is fixed to the first and second stabilizer beams proximate the respective beam first ends.

19. The machine of claim 17, wherein the first rail is fixed to the beam upper surface of the first stabilizer beam, and the second rail is fixed to the beam upper surface of the second stabilizer beam.

20. The machine of claim 17, wherein each stabilizer beam is sized to counteract a moment load exerted on the stabilizer beam in reaction to application of the clamping force, the moment load exerting a tensile force along an upper portion of each stabilizer beam adjacent the beam upper surface, and exerting a compressive force along a lower portion of each stabilizer beam adjacent the beam lower surface.

21. The machine of claim 20, wherein the beam height is at least 75 percent of a mold mounting surface height, the mold mounting surface height extending vertically between a mold mounting surface upper edge and a mold mounting surface lower edge of each of the opposed first and second mold mounting surfaces.

22. The machine of claim 20, wherein the beam thickness is at least 50 mm.

23. The machine of claim 15, wherein each of the first and second active force-exertion members comprises a clamp actuator coupled to a tie bar, the tie bar extending from the first platen and engageable with the second platen for exerting a clamp force across the first and second platens when in the mold-closed position, each tie bar extending along a respective tie bar axis parallel to the machine axis and at an elevation below the rail elevation.

24. The machine of claim 23, further comprising a locking device associated with each tie bar and mounted in the second platen, each locking device movable between a locked position for transferring axial force from the tie bar to the second platen during clamp-up, and an unlocked position in which the second platen is axially translatable relative to the tie bar, for movement between the mold open and mold closed positions.

25. The machine of claim 15, further comprising a platen stroke drive for translating the second platen between the mold-open and mold-closed positions, the platen stroke drive separate from the first and second active force exertion members.

26. A method of clamping together platens of a two-platen injection molding machine, comprising:
a) exerting a vertically offset compressive force across first and second platens by stretching first and second tie bars extending between and coupled to the first and second platens, the first and second platens oriented parallel to each other and at an elevation below a vertical midpoint of respective first and second mold mounting surfaces of the first and second platens, the vertically offset compressive force creating a moment load drawing lower portions of the first and second platens together more tightly than upper portions of the first and second platens;
b) using first and second stabilizer beams to counteract the moment load and urge the upper portions of the first and second platens together more tightly, the first and second stabilizer beams coupled to the first and second platens at an elevation below the vertical midpoint of the first and second mold mounting surfaces, and the first and second stabilizer beams having a beam height and a beam thickness sized to resist tensile forces along respective upper surfaces of the first and second stabilizer beams and to resist compressive forces along respective lower surfaces of the first and second stabilizer beams.

27. The method of claim 26, further comprising, prior to step (a), sliding the second platen along first and second rails mounted to the respective upper surfaces of the first and second stabilizer beams to translate the second platen from a mold open position distal the first platen to a mold closed position proximate the first platen.
